(19) United States
(12) Patent Application Publication
(10) Pub. No.: US 2025/0343813 A1
(43) Pub. Date: Nov. 6, 2025

(54) IDENTIFYING DEVICES ON NETWORKED COMPUTER SYSTEMS THAT ORIGINATE MALICIOUS NETWORK TRAFFIC

(71) Applicant: MASTERCARD TECHNOLOGIES CANADA ULC, Vancouver (CA)

(72) Inventors: Kyle Williams, Wentzville, MO (US); David J. Senci, Troy, IL (US); Jonathan McGrandle, Maple Ridge (CA)

(21) Appl. No.: 19/194,872

(22) Filed: Apr. 30, 2025

Related U.S. Application Data
(60) Provisional application No. 63/640,970, filed on May 1, 2024.

(51) Int. Cl. H04L 9/40

(52) U.S. Cl. CPC H04L 63/1425; H04L 63/1441

(57) ABSTRACT

A system includes and non-transitory computer-readable media storing instructions an electronic processor configured to execute the instructions to receive a screening payload from a client platform, the screening payload identifying an authorization request, identify a stored enhanced authorization request corresponding to the identified authorization request, the stored enhanced authorization request including first device characteristics, identify a device on a network having second device characteristics, the second device characteristics matching the first device characteristics, and transmit a control signal to the identified device, the control signal configured to cause the identified device to generate an alert.

### CROSS-REFERENCE TO RELATED APPLICATIONS

This application claims the benefit of U.S. Provisional Application No. 63/640,970 filed May 1, 2024, the entire disclosure of which is incorporated by reference.

### FIELD

The present disclosure relates to information security techniques and, more particularly, to information security techniques for identifying devices on networked computer systems that originate malicious network traffic.

### SUMMARY

Identifying malicious network traffic is beneficial to maintaining a robust network security posture. Identifying malicious network traffic may provide a variety of technical benefits. For example, the early detection of threats posed by malicious network traffic may minimize the impact of the malicious network traffic by stopping the threats before they escalate or mitigating the potential impact of further incidents. Furthermore, understanding the types of malicious traffic present within a network provides better situation awareness, which may be beneficial to making informed security decisions and enhancing the overall network security posture. However, falsely identifying benign network traffic as malicious (often referred to as “false positives”) may lead to numerous negative technical effects. For example, automatic actions taken in response to false positives, like rejecting network traffic, may degrade network performance and/or lead to service disruptions. Thus, techniques that aid in the identification of false positives may improve the overall performance of computer networks.

Some computer networks may include one or more originating client platforms, one or more intermediate client platforms, and one or more bridge platforms. Network traffic (including malicious network traffic) may be generated at an originating client platform, transmitted to an intermediate client platform, processed at the intermediate client platform, transmitted to the bridge platform, and transmitted onwards from the bridge platform to other platforms in the network. The bridge platform may log the network traffic passing through the platform along with characteristics of the originating client platform that generated the network traffic. When network traffic is identified as being potentially malicious, the bridge platform may identify the originating client platform that generated the potentially malicious network traffic based on the previously logged characteristics. Identifying the originating client platform may help the computer network and/or security analysts determine whether the potentially malicious network traffic is malicious or a false positive. For example, in response to the identified originating client platform being a trusted platform, the potentially malicious network traffic may be classified as a false positive. In response to the identified originating client platform being an unrecognized platform, the potentially malicious network traffic may be classified as malicious.

A system includes an non-transitory computer-readable media storing instructions an electronic processor configured to execute the instructions to receive a screening payload from a client platform, the screening payload identifying an authorization request, identify a stored enhanced authorization request corresponding to the identified authorization request, the stored enhanced authorization request including first device characteristics, identify a device on a network having second device characteristics, the second device characteristics matching the first device characteristics, and transmit a control signal to the identified device, the control signal configured to cause the identified device to generate an alert.

In other features, the stored enhanced authorization request includes a historical authorization request submitted by a historical device. In other features, the stored enhanced authorization request includes static attributes of the historical device. In other features, the stored enhanced authorization request includes dynamic attributes of the historical device. In other features, the stored enhanced authorization request includes hardware attributes of the historical device. In other features, the electronic processor is configured to generate a device fingerprint of the historical device based on at least one of the static attributes of the historical device, the dynamic attributes of the historical device, or the hardware attributes of the historical device. In other features, the stored enhanced authorization request includes the device fingerprint of the historical device. In other features, the identified device and the historical device are a same device.

A method includes receiving, with a networked computer platform, a screening payload from a client platform, the screening payload identifying an authorization request, identifying, with the networked computer platform, a stored enhanced authorization request corresponding to the identified authorization request, the stored enhanced authorization request including first device characteristics, identifying, with the networked computer platform, a device on a network having second device characteristics, the second device characteristics matching the first device characteristics, and transmitting, with the networked computer platform, a control signal to the identified device, the control signal configured to cause the identified device to generate an alert.

In other features, the stored enhanced authorization request includes an authorization request generated by a historical device. In other features, the stored enhanced authorization request includes static attributes of the historical device. In other features, the stored enhanced authorization request includes dynamic attributes of the historical device. In other features, the stored enhanced authorization request includes hardware attributes of the historical device. In other features, the method includes generating, at the networked computer platform, a device fingerprint of the historical device based on at least one of the static attributes of the historical device, the dynamic attributes of the historical device, or the hardware attributes of the historical device. In other features, the stored enhanced authorization request includes the device fingerprint of the historical device. In other features, the identified device and the historical device are a same device.

A non-transitory computer-readable medium includes executable instructions that, when executed by an electronic processor, cause an electronic processor to perform a set of operations includes receiving a screening payload from a client platform, the screening payload identifying an authorization request, the screening payload generated by a screening device, identifying a stored enhanced authorization request corresponding to the identified authorization request, the stored enhanced authorization request including first device characteristics, identifying a device on a network having second device characteristics, the second device characteristics matching the first device characteristics, determining a location of the identified device, and transmitting the location of the identified device to the screening device.

In other features, the stored enhanced authorization request includes a historical authorization request submitted by a historical device and at least one of static attributes of the historical device, dynamic attributes of the historical device, or hardware attributes of the historical device. In other features, the set of operations further include generating a device fingerprint of the historical device based on at least one of the static attributes of the historical device, the dynamic attributes of the historical device, or the hardware attributes of the historical device. In other features, the identified device and the historical device are a same device.

Other examples, embodiments, features, and aspects will become apparent by consideration of the detailed description and accompanying drawings.

### BRIEF DESCRIPTION OF THE DRAWINGS

FIG. 1 is a functional block diagram of a networked computer system, according to some examples.

FIGS. 2 and 3 are flowcharts of a process for identifying a device used to generate potentially malicious network traffic and generating an alert at the identified device, according to some examples.

FIG. 4 is a schematic illustration of an authorization request generated by a transactions application, according to some examples.

FIG. 5 is a schematic illustration of an enhanced authorization request generated by a network security application, according to some examples.

FIG. 6 is a message sequence chart showing interactions between components of a networked computer system as the system identifies a device used to generate potentially malicious network traffic and generates an alert at the identified device, according to some examples.

FIGS. 7 and 8 are flowcharts of a process for identifying a device used to generated potentially malicious network traffic and locating the identified device, according to some examples.

FIG. 9 is a message sequence chart showing interactions between components of a networked computer system as the system identifies a device used to generated potentially malicious network traffic and locates the identified device, according to some examples.

In the drawings, reference numbers may be reused to identify similar and/or identical elements.

### DETAILED DESCRIPTION

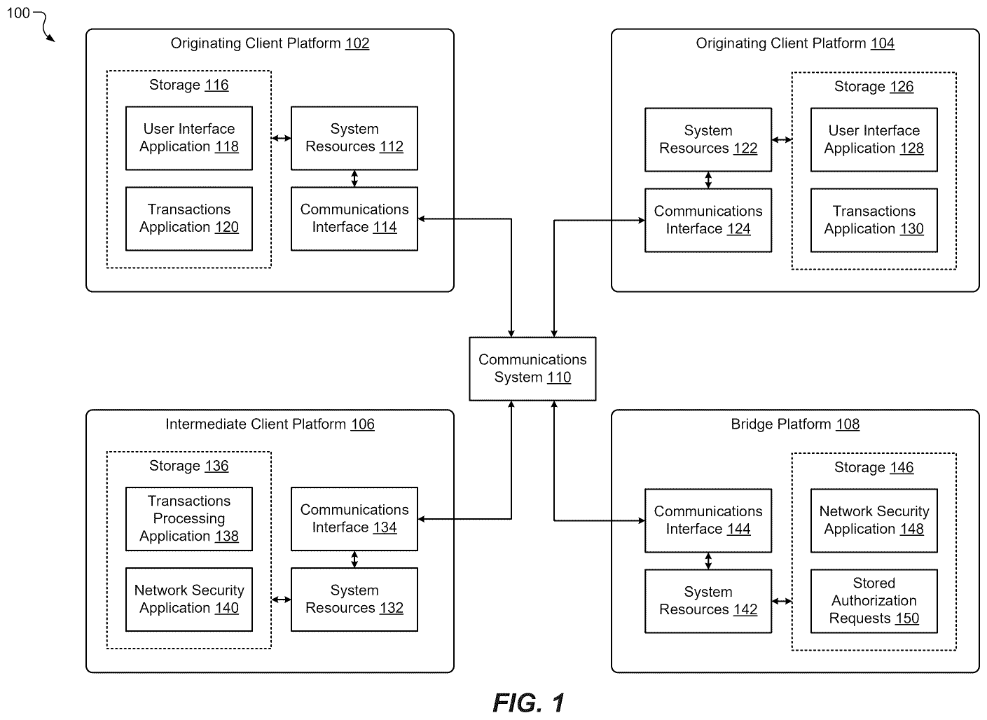

FIG. 1 is a functional block diagram of a networked computer system 100, according to some examples. As shown in FIG. 1, some implementations of the system 100 include an originating client platform 102, an originating client platform 104, an intermediate client platform 106, and a bridge platform 108. The originating client platform 102, the originating client platform 104, the intermediate client platform 106, and the bridge platform 108 may communicate with one another via a communications system 110.

Examples of the communications system 110 include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 110 includes an optical network, a local area network, and/or a global communication network, such as the Internet.

While only two originating client platforms 102 and 104, a single intermediate client platform 106, a single bridge platform 108, and a single communications system 110 are shown in FIG. 1, various implementations of the system 100 may include one or more of each platform and/or system. In various implementations, the originating client platform 102 includes system resources 112, a communications interface 114, and/or one or more data stores that include non-transitory computer-readable storage media, such as storage 116. The system resources 112 may include one or more electronic processors, one or more graphics processing units, volatile computer memory, non-volatile computer memory, and/or one or more system buses connecting components of the systems resources 112, the communications interface 114, and/or the storage 116. In some examples, the storage 116 includes one or more software applications, such as a user interface application 118 and/or a transactions application 120. Functionality of the user interface application 118 and the transactions application 120 will be described further on in this specification with reference to the flowcharts and/or message sequence charts.

In some embodiments, the originating client platform 104 includes system resources 122, a communications interface 124, and/or one or more data stores that include non-transitory computer-readable storage media, such as storage 126. The system resources 122 may include one or more electronic processors, one or more graphics processing units, volatile computer memory, non-volatile computer memory, and/or one or more system buses connecting components of the systems resources 122, the communications interface 124, and/or the storage 126. In some examples, the storage 126 includes one or more software applications, such as a user interface application 128 and/or a transactions application 130. Functionality of the user interface application 128 and the transactions application 130 will be described further on in this specification with reference to the flowcharts and/or message sequence charts.

In various implementations, the intermediate client platform 106 includes system resources 132, a communications interface 134, and/or one or more data stores that include non-transitory computer-readable storage media, such as storage 136. The system resources 132 may include one or more electronic processors, one or more graphics processing units, volatile computer memory, non-volatile computer memory, and/or one or more system buses connecting components of the systems resources 132, the communications interface 134, and/or the storage 136. In some examples, the storage 136 includes one or more software applications, such as a transactions processing application 138 and/or network security application 140. Functionality of the transactions processing application 138 and the network security application 140 will be described further on in this specification with reference to the flowcharts and/or message sequence charts.

In some examples, the bridge platform 108 includes system resources 142, a communications interface 144, and/or one or more data stores that include non-transitory computer-readable storage media, such as storage 146. The system resources 142 may include one or more electronic processors, one or more graphics processing units, volatile computer memory, non-volatile computer memory, and/or one or more system buses connecting components of the systems resources 142, the communications interface 144, and/or the storage 146. In some examples, the storage 146 includes one or more software applications, such as a network security application 148, and/or stored authorization requests 150. Functionality of the network security application 148 will be described further on in this specification with reference to the flowcharts and/or message sequence charts.

Components of the originating client platform 102, the originating client platform 104, the intermediate client platform 106, and/or the bridge platform 108 may communicate with each other via the communications system 110. For example, components of the originating client platform 102 may communicate with the communications system 110 via the communications interface 114, components of the originating client platform 104 may communicate with the communications system 110 via the communications interface 124, components of the intermediate client platform 106 may communicate with the communications system 110 via the communications interface 134, and components of the bridge platform 108 may communicate with the communications system 110 via the communications interface 144.

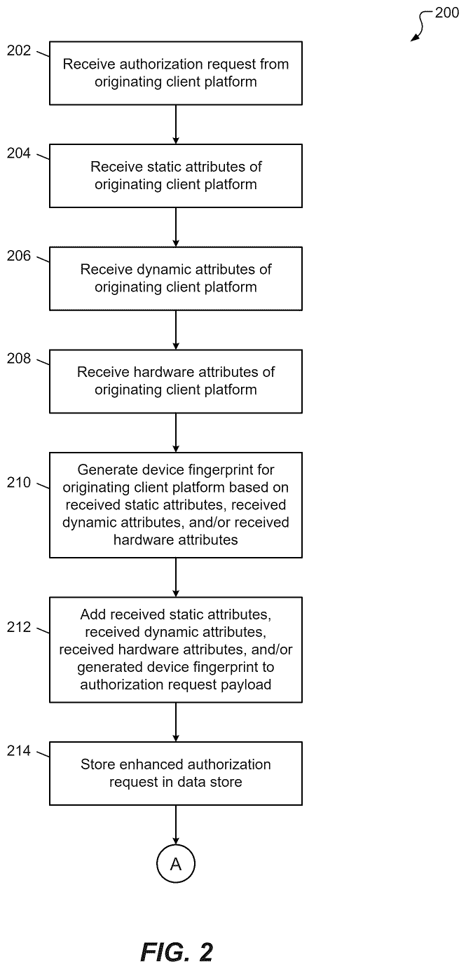

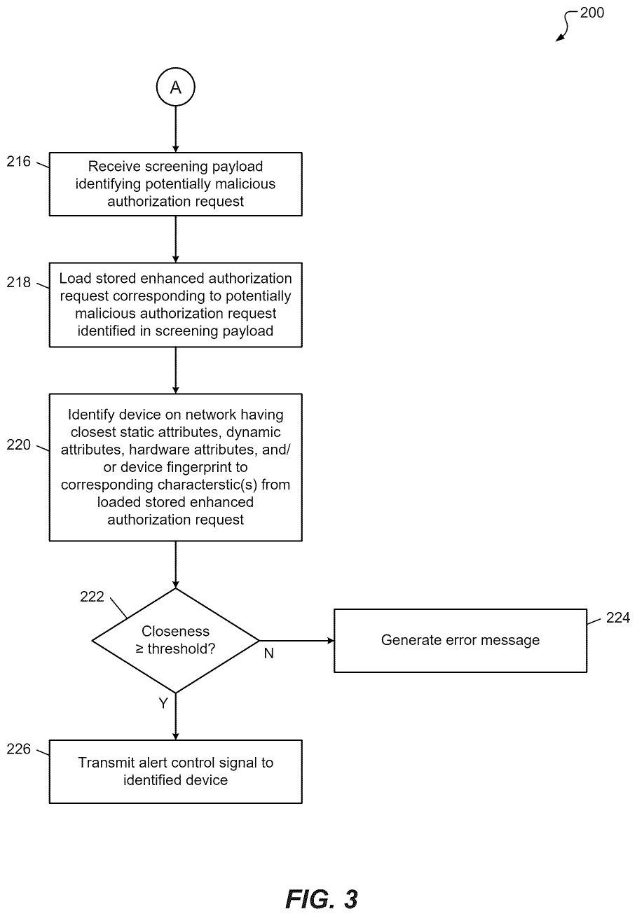

FIGS. 2 and 3 are flowcharts of a process 200 for identifying a device used to generate potentially malicious network traffic and generating an alert at the identified device, according to some examples. In the example process 200, the bridge platform 108 receives an authorization request from the originating client platform 102 (at block 202). For example, the user interface application 118 of the originating client platform 102 may generate a graphical user interface for a user to input credit card information (such as a primary account number, a card expiration date, and/or a card verification value), billing information (such as a billing address), user account data (such as login information for a user account on the originating client platform 102), and/or a transaction amount. The transactions application 120 may add the information input into the graphical user interface to the authorization request. In various implementations, the transactions application 120 may determine a type of authorization the user is requesting (for example, whether the user is requesting a purchase transaction or a refund transaction), log a date and time of the user's request, and/or log an Internet Protocol (IP) address of the user. The transactions application 120 may generate the authorization request based on the information input into the graphical user interface, the logged information, and/or additional information generated by the transactions application 120.

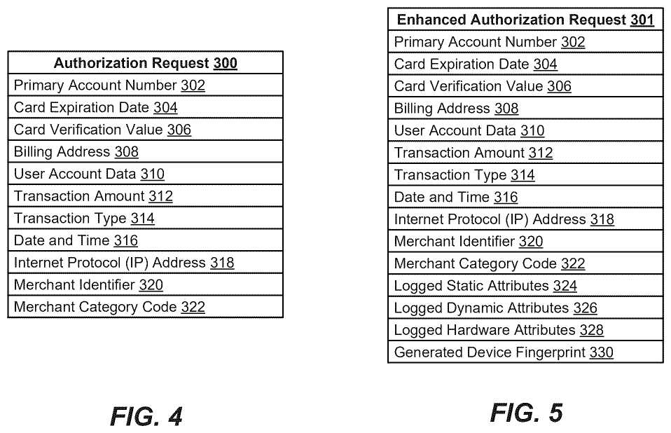

FIG. 4 is a schematic illustration of an authorization request 300 generated by the transactions application 120, according to some examples. For example, as shown in FIG. 4, the authorization request 300 may include a primary account number 302, a card expiration date 304, a card verification value 306, a billing address 308, user account data 310, a transaction amount 312, a transaction type 314, a date and time 316, an IP address 318, a merchant identifier 320, and/or a merchant category code 322.

In various implementations, the primary account number 302 includes a sequence of digits uniquely identifying a cardholder account, for example, formatted according to the ISO/IEC 7812 standard. In some examples, the primary account number 302 includes a combination of components, such as a bank identification number (BIN), an individual account identifier, and/or a check digit. For instance, the first 6-8 digits of the primary account number 302 may represent the BIN, which identifies the issuing institution. The subsequent digits of the primary account number 302 may represent an account number that uniquely identifies the cardholder within the issuing institution's system. The final digit may be a check digit computed to validate the integrity of the primary account number 302 (for example, computed according to the Luhn algorithm, the Verhoeff algorithm, the Damm algorithm, the ISO/IEC 7064 algorithm, or any other suitable algorithm).

In various implementations, the primary account number 302 includes a payment token. Structurally, a tokenized primary account number 302 may include a surrogate identifier that preserves the format of a numerical account number (for example, as previously described) while decoupling the identifier from the actual underlying account. For example, the token may retain a BIN-like prefix assigned from a range designed for tokenized values and may include randomized or otherwise non-sensitive digits in place of the actual account identifier. A tokenized primary account number 302 may be issued and managed by a token service provider, which maps the token to an actual numerical account number via a secure token vault.

After the transactions application 120 generates the authorization request 300, the authorization request 300 is transmitted to the transactions processing application 138 at the intermediate client platform 106. The network security application 140 may log certain characteristics of the originating client platform 102. For example, the network security application 140 may log static attributes, dynamic attributes, and/or hardware attributes of the originating client platform 102.

Examples of static attributes include details about the operating system installed on the device (such as the operating system name, version, architecture, installation date, and/or kernel version), details about other software installed on the device, the software configuration of the device, the file system type of the device, the browser name and/or version used to submit the authorization request, details about installed browser extensions and plugins, the hostname of the device, the domain affiliation of the device, installed digital certificates on the device, the screen resolution of the device, and/or the color depth of the device.

Examples of dynamic attributes include the Internet Protocol (IP) address of the device, information about networks the device is currently connected to, the data usage metrics of the device (such as the amount of data sent and/or received over a certain period), session cookies stored by the browser of the device, and/or details associated with the user agent of the device. Examples of hardware attributes include a serial number of the device, a model number of the device, a MAC address of the device, a device ID, a telephone number of the device, CPU specification of the device, RAM specifications of the device, details about the system BIOS/UEFI, details about the communications interface, details about the GPU, and/or details about the screen of the device (such as the size, resolution, and technology type).

In various implementations, hardware attributes include International Mobile Equipment Identity (IMEI) numbers, which are globally unique identifiers assigned to mobile devices during manufacturing. IMEI numbers are typically embedded in hardware components such as the modem or baseband processor, making them persistent across device resets and resistant to tampering. Because of their uniqueness and hardware-level binding, IMEI numbers may serve as reliable identifiers that may be used to distinguish devices, track device behavior over time, and support device-level authentication or risk scoring.

In some examples, hardware attributes include IMEI state associated with an IMEI number, which reflects the current classification or reputation of the device based on data from mobile network operators, centralized databases, or enterprise security policies. IMEI states may indicate whether a device is considered trustworthy or potentially malicious. Example IMEI states include “valid” (recognized and unflagged), “blacklisted” (reported as lost, stolen, or used in fraudulent activity), “whitelisted” (explicitly approved for use), “provisionally flagged” (under review or pending investigation), and “duplicate” (potentially cloned or spoofed). Incorporating IMEI state analysis into device profiling may improve the precision of threat detection and classification mechanisms.

In various implementations, hardware attributes include additional IMEI-related attributes to enhance identification and device fingerprinting. For example, hardware attributes may include the IMEI Software Version (IMEI-SV), which includes the base IMEI along with a two-digit code representing the version of the device's modem firmware. Hardware attributes may include the Type Allocation Code (TAC), which consists of the first eight digits of the IMEI, identifies the device's manufacturer and model. The remaining digits may include a unique serial number and a checksum digit used to validate the IMEI using the Luhn algorithm.

Hardware attributes may include historical metrics associated with the IMEI. For example, a system may also track historical IMEI values reported by the device, observe the frequency of IMEI changes (as an indicator of spoofing or emulation), and/or correlate IMEI values with identifiers such as IMSI or SIM card data to detect behavioral anomalies like SIM swapping. When combined with other hardware, static, and dynamic attributes, these IMEI-based characteristics contribute to a robust fingerprinting framework for detecting and responding to potentially malicious devices.

After logging the static attributes, dynamic attributes, and/or hardware attributes of the originating client platform 102, the transactions processing application 138 transmits the authorization request 300 and the logged static attributes, logged dynamic attributes, and/or logged hardware attributes to the network security application 148 of the bridge platform 108. Returning to FIG. 2, in the example process 200, the network security application 148 receives the static attributes of the originating client platform 102 (at block 204).

In the example process 200, the network security application 148 receives the dynamic attributes of the originating client platform 102 (at block 206). In the example process 200, the network security application 148 receives the hardware attributes of the originating client platform 102 (at block 208). In the example process 200, the network security application 148 may generate a device fingerprint based on the received static attributes, the received dynamic attributes, and/or the received hardware attributes (at block 210). In the example process 200, the network security application 148 adds the received static attributes, received dynamic attributes, received hardware attributes, and/or the generated device fingerprint to the authorization request 300, generating an enhanced authorization request (at block 212). In the example process 200, the network security application 148 saves the enhanced authorization request to stored authorization requests 150 (at block 214).

FIG. 5 is a is a schematic illustration of an enhanced authorization request 301 generated by the network security application 148, according to some examples. As illustrated in FIG. 5, the enhanced authorization request 301 includes elements 302-322 from the authorization request 300, as well as the logged static attributes 324, the logged dynamic attributes 326, the logged hardware attributes 328, and/or the generated device fingerprint 330. In various implementations, the authorization request 300 and/or elements 302-322 may be considered a historical authorization request submitted by a historical device. Returning to FIG. 3, in the example process 200, the network security application 148 receives a screening payload from the originating client platform 104 (at block 216). In various implementations, transactions application 130 interacts with intermediate client platform 106 and/or bridge platform 108 to generate a list of authorization requests submitted over a time period. The user reviews the list of authorization requests via the user interface application 128 and flags a potentially malicious authorization request. The transactions applications 130 generates the screening payload identifying the potentially malicious authorization request and transmits the screening payload to the network security application 148 at the bridge platform 108. In various implementations, the originating client platform 102 may generate the screening payload and transmit the screening payload to the network security application 148.

In the example process 200, the network security application 148 parses the enhanced authorization requests of stored authorization requests 150 and loads the stored enhanced authorization request corresponding to the potentially malicious authorization request identified in the screening payload (at block 218). In the example process 200, in various implementations, the network security application 148 identifies the device in the networked computer system 100 having the closest static attributes, dynamic attributes, and/or hardware attributes to the corresponding attribute(s) from the loaded stored enhanced authorization request (at block 220). In some embodiments, the network security application 148 identifies the device in the networked computer system 100 having the closest device fingerprint to the corresponding device fingerprint from the loaded stored enhanced authorization request. In the example process 200, the network security application 148 determines whether the closeness meets or exceeds a threshold (at decision block 222). In various implementations, the threshold may be about a 5%, 10%, 15%, 20%, 25%, 30%, 35%, 40%, 45%, 50%, 55%, 60%, 65%, 70%, 75%, 80%, 85%, 90%, 95%, or 100% match.

In response to determining that the closeness does not meet or exceed the threshold (“NO” at decision block 222), the network security application 148 generates an error message (at block 224). The network security application 148 may transmit the error message to the transactions application 130 at the originating client platform 104, and the transactions application 130 may output the error message to the user via the user interface application 128. In response to determining that the closeness meets or exceeds the threshold (“YES” at decision block 222), the network security application 148 generates and transmits an alert control signal to the identified device (at block 226). In various implementations, the identified device may be the originating client platform 102, and the network security application 148 transmits the alert control signal to the transactions application 120 of the originating client platform 102. In response to receiving the alert control signal, the transactions application 120 generates an alert at the originating client platform 102. In various implementations, the alert may be a visual alert output via a display, an audible alert output via speakers, and/or a haptic alert output via a haptic engine.

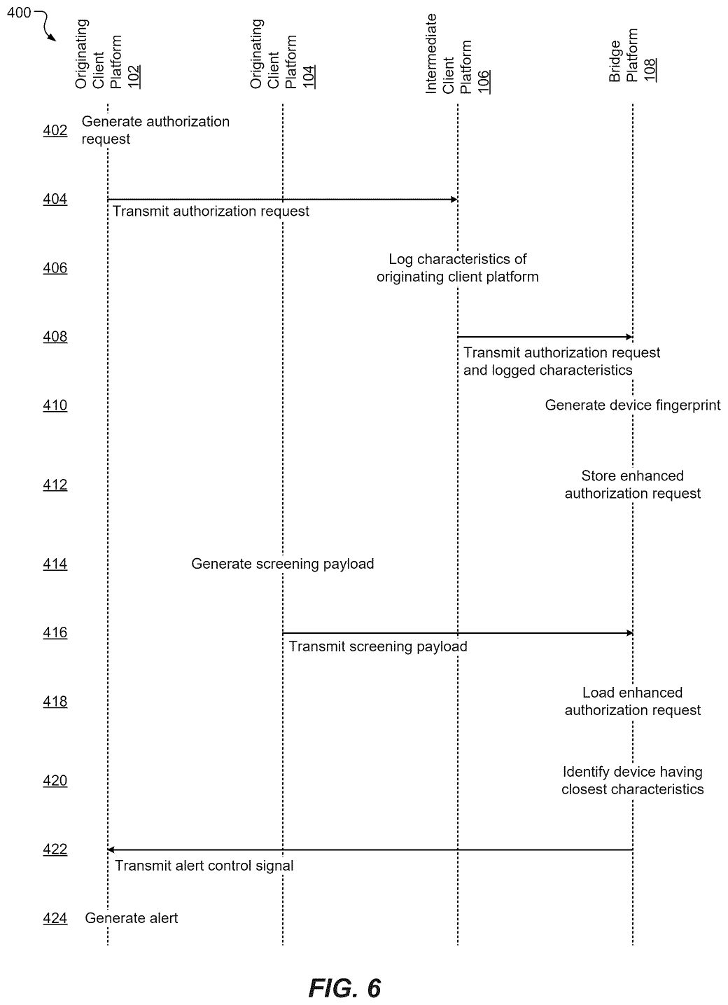

FIG. 6 is a message sequence chart 400 showing interactions between components of the networked computer system 100 as the system 100 identifies a device used to generated potentially malicious network traffic and generates an alert at the identified device, according to some examples. In the message sequence chart 400, the originating client platform 102 generates an authorization request (at operation 402). In the message sequence chart 400, the originating client platform 102 transmits the authorization request to the intermediate client platform 106 (at operation 404). In the message sequence chart 400, the intermediate client platform 106 logs characteristics of the originating client platform 102 (for example, the dynamic attributes, static attributes, and/or hardware attributes previously described with reference to FIGS. 2 and 3) (at operation 406). In the message sequence chart 400, the intermediate client platform 106 transmits the authorization request and the logged characteristics to the network security platform 108 (at operation 408). In the message sequence chart 400, the bridge platform 108 (optionally) generates a device fingerprint based on the logged characteristics (at operation 410). In the message sequence chart 400, the bridge platform 108 adds the logged characteristics and/or device fingerprint to the authorization request and stores the enhanced authorization request in storage 146 (at operation 412).

In the message sequence chart 400, the originating client platform 104 generates the screening payload identifying the potentially malicious authorization request (at operation 414). In the message sequence chart 400, the originating client platform 104 transmits the screening payload to the bridge platform 108 (at operation 416). In various implementations, the originating client platform 102 may generate and transmit the screening payload to the bridge platform 108. In the message sequence chart 400, the bridge platform 108 loads the enhanced authorization request matching the potentially malicious authorization request identified by the screening payload (at operation 418). In the message sequence chart 400, the network security platform identifies the device in the networked computer system 100 having the closest characteristics and/or device fingerprint as with the corresponding characteristics and/or device fingerprint in the enhanced authorization request (at operation 420). For example, the network security platform 108 identifies the originating client platform 102 as the device having the closest characteristics and/or device fingerprint. In the message sequence chart 400, the network security platform 108 transmits an alert control signal to the originating client platform 102 (at operation 422). In the message sequence chart 400, the originating client platform generates an alert in response to receiving the alert control signal (at operation 424).

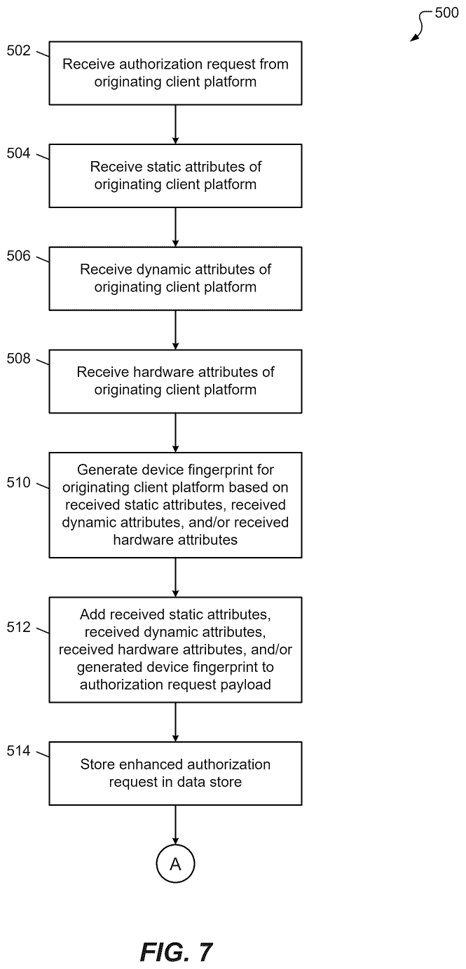

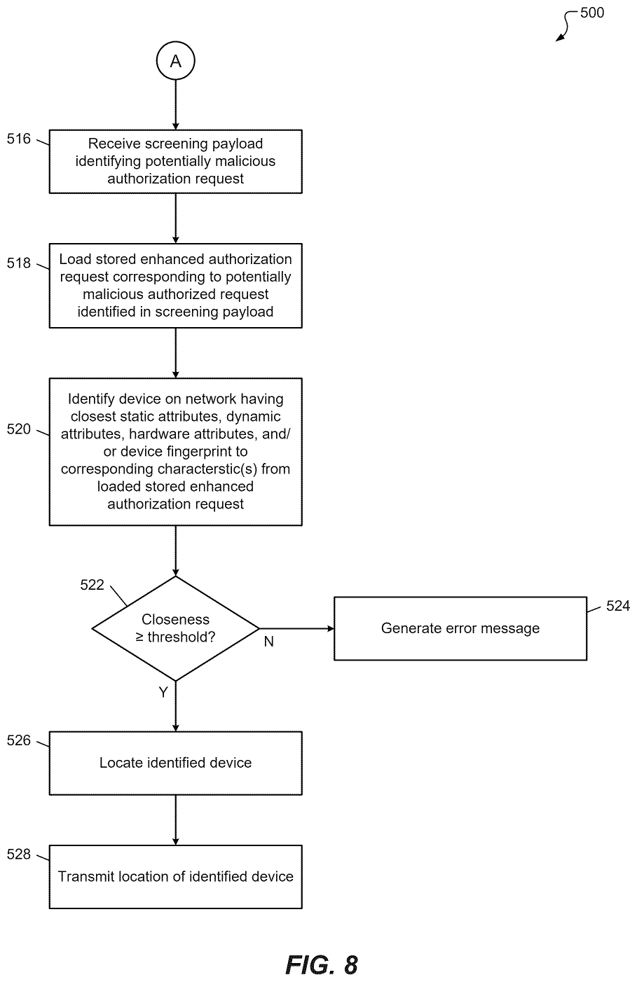

FIGS. 7 and 8 are flowcharts of a process 500 for identifying a device used to generated potentially malicious network traffic and locating the identified device, according to some examples. In the example process 500, the bridge platform 108 receives an authorization request from the originating client platform 102 (for example, as previously described with reference to block 202) (at block 502). In the example process 500, the network security application 148 receives the static attributes of the originating client platform 102 (at block 504). In the example process 500, the network security application 148 receives the dynamic attributes of the originating client platform 102 (at block 506). In the example process 500, the network security application 148 receives the hardware attributes of the originating client platform 102 (at block 508). In the example process 500, the network security application 148 may generate a device fingerprint based on the received static attributes, the received dynamic attributes, and/or the received hardware attributes (at block 510). In the example process 500, the network security application 148 adds the received static attributes, received dynamic attributes, received hardware attributes, and/or the generated device fingerprint to the authorization request 300, generating an enhanced authorization request (at block 512). In the example process 500, the network security application 148 saves the enhanced authorization request to stored authorization requests 150 (at block 514).

In the example process 500, the network security application 148 receives a screening payload from the originating client platform 104 (at block 516). In various implementations, transactions application 130 interacts with intermediate client platform 106 and/or bridge platform 108 to generate a list of authorization requests submitted over a time period. The user reviews the list of authorization requests via the user interface application 128 and flags a potentially malicious authorization request. The transactions applications 130 generates the screening payload identifying the potentially malicious authorization request and transmits the screening payload to the network security application 148 at the bridge platform 108. In various implementations, the originating client platform 102 may generate the screening payload and transmit the screening payload to the network security application 148.

In the example process 500, the network security application 148 parses the enhanced authorization requests of stored authorization requests 150 and loads the stored enhanced authorization request corresponding to the potentially malicious authorization request identified in the screening payload (at block 518). In the example process 500, in various implementations, the network security application 148 identifies the device in the networked computer system 100 having the closest static attributes, dynamic attributes, and/or hardware attributes to the corresponding attribute(s) from the loaded stored enhanced authorization request (at block 520). In some embodiments, the network security application 148 identifies the device in the networked computer system 100 having the closest device fingerprint to the corresponding device fingerprint from the loaded stored enhanced authorization request. In the example process 500, the network security application 148 determines whether the closeness meets or exceeds a threshold (at decision block 522). In various implementations, the threshold may be about a 5%, 10%, 15%, 20%, 25%, 30%, 35%, 40%, 45%, 50%, 55%, 60%, 65%, 70%, 75%, 80%, 85%, 90%, 95%, or 100% match.

In response to determining that the closeness does not meet or exceed the threshold (“NO” at decision block 522), the network security application 148 generates an error message (at block 524). The network security application 148 may transmit the error message to the transactions application 130 at the originating client platform 104, and the transactions application 130 may output the error message to the user via the user interface application 128. In response to determining that the closeness meets or exceeds the threshold (“YES” at decision block 522), the network security application 148 locates the identified device (at block 526). In various implementations, the network security application 148 requests a GPS location from the originating client platform 102. In some embodiments, the network security application 148 generates an approximate location of the originating client platform 102 based on network information (such as an IP address of the originating client platform 102 and/or a location of a cellular tower the originating client platform 102 is connected to). In the example process 500, the network security application 148 transmits the location of the identified device to the device that the network security application 148 received the screening payload from at block 516 (at block 528). For instance, in examples where the network security application 148 received the screening payload from the originating client platform 104 at block 516, the network security application 148 transmits the location of the identified device to the transactions application 130 of the originating client platform 104, and the user interface application 128 renders the location of the identified device on a display of the originating client platform 104.

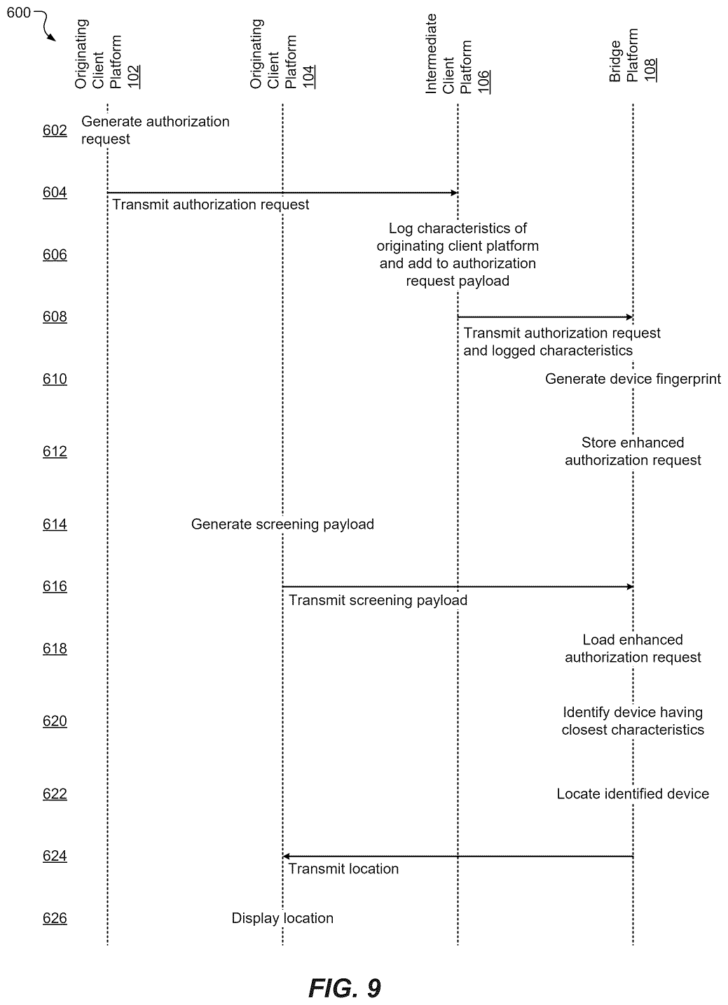

FIG. 9 is a message sequence chart 600 showing interactions between components of the networked computer system 100 as the system 100 identifies a device used to generate potentially malicious network traffic and locates the identified device, according to some examples. In the message sequence chart 600, the originating client platform 102 generates an authorization request (at operation 602). In the message sequence chart 600, the originating client platform 102 transmits the authorization request to the intermediate client platform 106 (at operation 604). In the message sequence chart 600, the intermediate client platform 106 logs characteristics of the originating client platform 102 (for example, the dynamic attributes, static attributes, and/or hardware attributes previously described with reference to FIGS. 2 and 3) (at operation 606). In the message sequence chart 600, the intermediate client platform 106 transmits the authorization request and the logged characteristics to the network security platform 108 (at operation 608). In the message sequence chart 600, the bridge platform 108 (optionally) generates a device fingerprint based on the logged characteristics (at operation 610). In the message sequence chart 600, the bridge platform 108 adds the logged characteristics and/or device fingerprint to the authorization request and stores the enhanced authorization request in storage 146 (at operation 612).

In the message sequence chart 600, the originating client platform 104 generates the screening payload identifying the potentially malicious authorization request (at operation 614). In the message sequence chart 600, the originating client platform 104 transmits the screening payload to the bridge platform 108 (at operation 616). In various implementations, the originating client platform 102 may generate and transmit the screening payload to the bridge platform 108. In the message sequence chart 600, the bridge platform 108 loads the enhanced authorization request matching the potentially malicious authorization request identified by the screening payload (at operation 618). In the message sequence chart 600, the network security platform identifies the device in the networked computer system 100 having the closest characteristics and/or device fingerprint as with the corresponding characteristics and/or device fingerprint in the enhanced authorization request (at operation 620). For example, the network security platform 108 identifies the originating client platform 102 as the device having the closest characteristics and/or device fingerprint. In the message sequence chart 600, the network security platform 108 locates the identified device (for example, as previously described with reference to block 526) (at operation 622). In the message sequence chart 600, the network security platform 108 transmits the location of the identified device to the device that generated and transmitted the screening payload at operations 614-616 (for example, the originating client platform 104) (at operation 624). In the message sequence chart 600, the device that generated and transmitted the screening payload at 614-616 (such as the originating client platform 104) renders and outputs the location of the identified device on a display (at operation 626).

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that may be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices—such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A system comprising:
non-transitory computer-readable media storing instructions; and
an electronic processor configured to execute the instructions to:
receive a screening payload from a client platform, the screening payload identifying an authorization request,
identify a stored enhanced authorization request corresponding to the identified authorization request, the stored enhanced authorization request including first device characteristics,
identify a device on a network having second device characteristics, the second device characteristics matching the first device characteristics, and
transmit a control signal to the identified device, the control signal configured to cause the identified device to generate an alert.

2. The system of claim 1, wherein the stored enhanced authorization request includes a historical authorization request submitted by a historical device.

3. The system of claim 2, wherein the stored enhanced authorization request includes static attributes of the historical device.

4. The system of claim 3, wherein the stored enhanced authorization request includes dynamic attributes of the historical device.

5. The system of claim 4, wherein the stored enhanced authorization request includes hardware attributes of the historical device.

6. The system of claim 5, wherein the electronic processor is configured to generate a device fingerprint of the historical device based on at least one of the static attributes of the historical device, the dynamic attributes of the historical device, or the hardware attributes of the historical device.

7. The system of claim 6, wherein the stored enhanced authorization request includes the device fingerprint of the historical device.

8. The system of claim 2, wherein the identified device and the historical device are a same device.

9. A method comprising:
receiving, with a networked computer platform, a screening payload from a client platform, the screening payload identifying an authorization request;
identifying, with the networked computer platform, a stored enhanced authorization request corresponding to the identified authorization request, the stored enhanced authorization request including first device characteristics;
identifying, with the networked computer platform, a device on a network having second device characteristics, the second device characteristics matching the first device characteristics; and
transmitting, with the networked computer platform, a control signal to the identified device, the control signal configured to cause the identified device to generate an alert.

10. The method of claim 9, wherein the stored enhanced authorization request includes an authorization request generated by a historical device.

11. The method of claim 10, wherein the stored enhanced authorization request includes static attributes of the historical device.

12. The method of claim 11, wherein the stored enhanced authorization request includes dynamic attributes of the historical device.

13. The method of claim 12, wherein the stored enhanced authorization request includes hardware attributes of the historical device.

14. The method of claim 13, further comprising:
generating, at the networked computer platform, a device fingerprint of the historical device based on at least one of the static attributes of the historical device, the dynamic attributes of the historical device, or the hardware attributes of the historical device.

15. The method of claim 14, wherein the stored enhanced authorization request includes the device fingerprint of the historical device.

16. The method of claim 10, wherein the identified device and the historical device are a same device.

17. A non-transitory computer-readable medium comprising executable instructions that, when executed by an electronic processor, cause an electronic processor to perform a set of operations comprising:
receiving a screening payload from a client platform, the screening payload identifying an authorization request, the screening payload generated by a screening device;
identifying a stored enhanced authorization request corresponding to the identified authorization request, the stored enhanced authorization request including first device characteristics;
identifying a device on a network having second device characteristics, the second device characteristics matching the first device characteristics;
determining a location of the identified device; and
transmitting the location of the identified device to the screening device.

18. The non-transitory computer-readable medium of claim 17, wherein the stored enhanced authorization request includes a historical authorization request submitted by a historical device and at least one of static attributes of the historical device, dynamic attributes of the historical device, or hardware attributes of the historical device.

19. The non-transitory computer-readable medium of claim 18, wherein the set of operations further include generating a device fingerprint of the historical device based on at least one of the static attributes of the historical device, the dynamic attributes of the historical device, or the hardware attributes of the historical device.

20. The non-transitory computer-readable medium of claim 18, wherein the identified device and the historical device are a same device.
